(19) United States
(12) Patent Application Publication
(10) Pub. No.: US 2022/0122017 A1
(43) Pub. Date: Apr. 21, 2022

(54) SYSTEM AND METHOD FOR ACCELERATING AND OPTIMIZING LEARNING RETENTION AND BEHAVIOR CHANGE

(71) Applicant: qChange Software Solution Inc, Bend, OR (US)

(72) Inventors: James Branson Kelley, Bend, OR (US); Robert Alan Buckingham, Bend, OR (US); John Conroy Howes, Bend, OR (US)

(73) Assignee: qChange Software Solution Inc, Bend, OR (US)

(21) Appl. No.: 17/502,913

(22) Filed: Oct. 15, 2021

Related U.S. Application Data
(60) Provisional application No. 63/205,115, filed on Nov. 18, 2020.
(60) Provisional application No. 63/204,652, filed on Oct. 16, 2020.

(51) Int. Cl. G06Q 10/06; G06K 9/00; H04L 12/18; G06Q 50/20

(52) U.S. Cl. CPC G06Q 10/06395; G06Q 50/2057; H04L 12/1831; G06K 9/00335

(57) ABSTRACT

A system that accelerates learning retention and behavior change provides users with automated actionable prompts targeted to specific behavioral growth areas that are concurrently matched to the topic of a scheduled meeting in a calendaring system. Users receive various forms of feedback from selected meeting participants and other agents, such as a video recording of the meeting. The system generates a metric control based on the execution of the actionable prompt. A closed loop system is formed by applying the feedback, agent input, scoring, and historical usage from the user and other users of the system as inputs to the system for adaptive learning.

### CROSS REFERENCE TO RELATED APPLICATIONS

This application claims priority and benefit to U.S. application Ser. No. 63/205,115, titled “System and method for accelerating and optimizing learning retention and behavior change”, filed on Nov. 18, 2020, and to U.S. application Ser. No. 63/202,652, titled “System and method for automatic determination and classification of multiple dyadic speaker/listener interactions through audio/visual analysis”, filed on Oct. 16, 2020, the contents of each being incorporated herein by reference in their entirety.

### BACKGROUND

Many tools and applications exist to assign sentiment to a speaker words or tone being spoken. Also, existing tools can assign automatically recognize gestures captured by video from a speaker or listener. However, these existing tools and applications generally calculate and display sentiment and gestures separately without a second or third order calculation and application of behavioral or emotional impact to the listeners. Although these existing tools and applications may enable users to understand the amount of time each person has spoken in a recorded meeting, provide an overall sentiment measure at points during the meeting from the speaker's perspective, and provide a summary score post meeting, there is a need for better matching between a speaker's sentiment and listener gestures, with a correlated measure of the emotional and behavioral impact from the listener's perspective.

Existing systems also lack efficient mechanisms, integral with natural work flows, to drive a behavioral modification cycle in targeted areas. Specifically, there is a long felt need for systems that analyze, calculate, and apply a perception gap between how a speaker believes they performed, versus the perception of others.

### Brief Summary

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an analytic system 100 in one embodiment.

FIG. 2 depicts a feedback driver loop 200 in one embodiment.

FIG. 3 depicts a driver loop control 300 in one embodiment.

FIG. 4 depicts a process 400 in one embodiment.

FIG. 5 depicts a process 500 in one embodiment.

FIG. 6 depicts a survey 600 in one embodiment.

FIG. 7 depicts a client server network configuration 700 in one embodiment.

FIG. 8 depicts a machine 800 in the form of a computer system within which a set of instructions may be executed for causing the machine to perform any one or more of the methodologies discussed herein, in one embodiment.

### DETAILED DESCRIPTION

The following description may be better understood with reference to the following terms. Other terms should be accorded their ordinary meaning in the art unless otherwise indicated by context.

“Algorithm” refers to any set of instructions configured to cause a machine to carry out a particular function or process.

“App” refers to a type of application with limited functionality, most commonly associated with applications executed on mobile devices. Apps tend to have a more limited feature set and simpler user interface than applications as those terms are commonly understood in the art.

“Application” refers to any software that is executed on a device above a level of the operating system. An application will typically be loaded by the operating system for execution and will make function calls to the operating system for lower-level services. An application often has a user interface but this is not always the case. Therefore, the term ‘application’ includes background processes that execute at a higher level than the operating system.

“Application program interface” refers to instructions implementing entry points and return values to a module.

“Behavioral nudge” refers to a signal communicated over a computer network between networked devices. A behavioral nudge signal comprises content identifying a manner in which a person can adapt their behavior in a specific manner.

“Calendaring system” refers to software for defining and scheduling meetings via the composition and addition, on an electronic calendar, of meeting objects, which typically identify at least meeting participants, a meeting subject, and a meeting start time and ending time (e.g., by time interval).

“File” refers to a unitary package for storing, retrieving, and communicating data and/or instructions. A file is distinguished from other types of packaging by having associated management metadata utilized by the operating system to identify, characterize, and access the file.

“Instructions” refers to symbols representing commands for execution by a device using a processor, microprocessor, controller, interpreter, or other programmable logic. Broadly, ‘instructions’ can mean source code, object code, and executable code. ‘instructions’ herein is also meant to include commands embodied in programmable read-only memories (EPROM) or hard coded into hardware (e.g., ‘micro-code’) and like implementations wherein the instructions are configured into a machine memory or other hardware component at manufacturing time of a device.

“Logic” refers to any set of one or more components configured to implement functionality in a machine. Logic includes machine memories configured with instructions that when executed by a machine processor cause the machine to carry out specified functionality; discrete or integrated circuits configured to carry out the specified functionality; and machine/device/computer storage media configured with instructions that when executed by a machine processor cause the machine to carry out specified functionality. Logic specifically excludes software per se, signal media, and transmission media.

“Meeting leader” refers to a meeting participant configured in the system to be the subject of behavioral analysis, surveying, and nudging for behavioral change.

“Meeting monitor” refers to logic that interacts with a calendaring system to receive triggering events.

“Meeting object” refers to a collection of persistent settings in a calendaring system to identify a meeting.

“Module” refers to a computer code section having defined entry and exit points. Examples of modules are any software comprising an application program interface, drivers, libraries, functions, and subroutines.

“Perception gap” refers to a measure of distance or offset between a person's perception of their behavior and the perception of their behavior by third parties and/or behavioral classifier logic.

“Plug-in” refers to software that adds features to an existing computer program without rebuilding (e.g., changing or re-compiling) the computer program. Plug-ins are commonly used for example with Internet browser applications.

“Process” refers to software that is in the process of being executed on a device.

“Programmable device” refers to any logic (including hardware and software logic) who's operational behavior is configurable with instructions.

“Service” refers to a process configurable with one or more associated policies for use of the process. Services are commonly invoked on server devices by client devices, usually over a machine communication network such as the Internet. Many instances of a service may execute as different processes, each configured with a different or the same policies, each for a different client.

“Software” refers to logic implemented as instructions for controlling a programmable device or component of a device (e.g., a programmable processor, controller). Software can be source code, object code, executable code, machine language code. Unless otherwise indicated by context, software shall be understood to mean the embodiment of said code in a machine memory or hardware component, including “firmware” and micro-code.

“Task” refers to one or more operations that a process performs.

“Triggering event” refers to the starting or ending time of a meeting as defined by a meeting object.

Embodiments of systems and techniques are described herein for accelerating and optimizing learning retention and behavior change. The systems provide users with automated actionable prompts targeted to specific behavioral growth areas that are concurrently matched to the topic of a scheduled meeting in a calendaring system. Users receive various forms of feedback from selected meeting participants and other agents, such as a video recording of the meeting. The system generates a metric control based on the execution of the actionable prompt. A closed loop system is formed by applying the feedback, agent input, scoring, and historical usage from the user and other users of the system as inputs to the system for adaptive learning. The systems deliver a relevant behavioral prompt to the user and measure the action of that prompt within a meeting environment, by the meeting attendees. A metric control is generated for that behavioral area based on that feedback.

The system operates to improve the efficiency and rate of change of learning retention. Conventional training techniques demonstrate a learning retention level on the order of 10% after fourteen days (Ebbinghaus Forgetting Curve). The system, when properly operated and applied, may increase retention by multiples of this level. The system implements a signaling and control loop that tracks and adjusts an end-to-end “thread” for behavioral change (from user selection, nudging, feedback, and metrification) focused on one actionable behavior. The system includes logic to identify meeting intent and match it to a selected behavioral area. The system operates as a closed loop system by selecting and delivering behavioral nudges in accordance with critical timing constraints based on a multitude of variables.

The system provides accelerated adaptation and fewer points of delay than do conventional learning systems. Provided there is a consistent tempo of meetings and sufficient influencers in attendance, there are no points at which the driver loop or feedback loop encounter stalls. Learning and adaptation are therefore made continuous under these circumstances.

The system also provides an efficient mechanism for semi-supervised machine learning. The feedback loop for adaptive behavioral classifiers operates on an organic tempo according to the frequency and nature of meetings that would take place anyway. In conventional learning systems, supervised or semi-supervised learning is a process orthogonal to other business functions, and hence distracts from and requires human and machine resources separate from and in addition to those utilized in normal business operations. The system reduces such inefficiencies.

Users may select one or multiple area(s) to improve, or the system may select area(s) based on assessments, user progress or comparisons to others who have selected the same area(s) for example. Once a triggering event occurs, such as five (5) minutes before the start of a meeting for example, the system determines a prompt to deliver to the user. The system may select the prompt based on various factors, some of which may include prior scores, meeting attendees, meeting type, meeting size, meeting time and location, and duration of time working on the behavioral area. The system may deliver the prompt through various mechanisms, such as text, email or video conferencing or other real-time collaboration system as examples. After another triggering event occurs, such as the conclusion of a meeting, the system delivers a rating request to the user and to participants. The user and participants complete the initial rating and submit back to the system for calculations. The system analyses the submissions and calculates a perception gap, the difference between the user rating and a participant ratings. The perception gap is delivered to the user via various aforementioned mechanisms.

The user, upon receiving the numerical perception gap, may wish to receive more details on their implementation of the prompt. They may request, at which point the system will send, a request for more written information on how they did or did not exhibit the behavior described in the prompt. Participants, upon receiving the request for written information, can send the user written details of the behavior(s) observed. The system, based on configuration, can deliver each rating or feedback as anonymous or attributed to a participant.

The system analyzes numeric and written feedback, normalizing as appropriate, and delivers a score which is included in the calculated summary score for the area and an overall user score, for example. Based on various inputs such as the initial prompt, prior scores, consumption of recommended learning opportunities, and area or overall score trend, a learning opportunity is delivered to the user through various aforementioned mechanisms.

A user may request additional feedback to gain a more understanding of how they exhibited the behavior. This feedback will be received by the system, analyzed and included in calculated area and leader scores, for example. The system sends the user a learning opportunity that can be based on various factors, such as the initial prompt, prior scores, consumption of recommended learning opportunities, and area or overall score trend. As noted above, the system delivers a score which is included in the calculated summary score for the area and an overall user score. Scores can be displayed and compared in various ways, such as over time or in the form of a trend. They can also be compare to other users in the system to show progress.

Also disclosed are embodiments of a system and method for automatic determination and classification of multiple dyadic speaker/listener interactions through audio and visual analysis. More particularly, the present disclosure describes an automated method for cross-classifying speaker and listener sentiments along a video conference timeline. The present disclosure also provides a method for classifying speaker and listener impact, and presenting a view to one or more of the group of conference participants of the impacted areas.

A video analysis system may operate on a previously recorded video file or during a real-time streaming of the video feed. It incorporates multiple levels and formats for sentiment analysis, and multiple classification methods and calculation engines to identify specific emotional and behavioral impacts on the listener. In addition to listener impact, the system calculates and displays behavioral nudges for the speaker to increase the desired impact on current and future listener audiences.

Once a video has been acquired by the system an initial sentiment analysis is performed based on each speaker's words and tone. Next, gesture analysis is performed for each listener where additional sentiment is identified based on speaker and images presented by speaker. Speaker and listener sentiment is classified along the meeting timeline, where additional sentiment categories are assigned based on the speaker/listener interaction. Additional analysis and classification may be performed to further clarify the listener impact. For example, normalization calculations may be performed to take into account prior sentiment measurements. In one embodiment, the system displays various measures to assist the user in understanding listener impact and audience analysis.

The user may configure various settings, representing measurement categories important to a user's objective. Content from a recorded video is presented, identifying specific areas in the video where the category was identified. Specific opportunities and nudges are then presented to the user based on these settings. The user may configure selection of a specific meeting attendee. Content from the video is presented, identifying specific areas in the video where the specific meeting attendee was identified as a speaker and the total talk time for that speaker from the entire conversation. Users may search for a specific word or phrase in the meeting. Upon finding the word or phrase, the system identifies those moments in the meeting timeline, and when selected by the user, displays a transcript of the conversation.

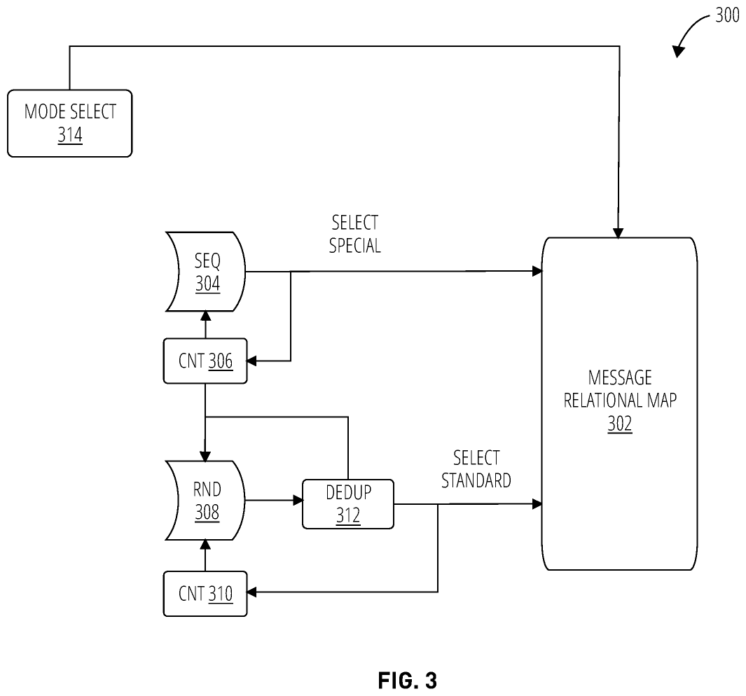

Table 1 below shows behavioral modalities that the system may track and associated nudges, survey prompts, and learning messages. This relational structure is referred to herein as a “message relational map”. For an example application of such a mapping structure in a control/driver loop, see the message relational map 302 in FIG. 3.

TABLE 1

| | Behavioral | Questions | Questions | |
|---|---|---|---|---|
| Modality | Nudge | for Leaders | to Followers | Learning Message |
| Internal | In this meeting, | In this | In this | Remember that praise |
| | be mindful of the | meeting I let | meeting, I | and recognition |
| | pressures the | my team | feel like | works better if you |
| | team is under and | know how | {LEADER} | can be very specific |
| | be sure to give | much their | let us know | in matching the |
| | some praise and | effort and | how much | praise to the specific |
| | recognition for | work is | our effort | effort or result that |
| | their efforts. | appreciated. | and work is | you wanted. |
| | | | appreciated. | |
| External | In this meeting, | In this | In this | Simple gestures mean |
| | show the team | meeting I let | meeting, I | a lot. Consider |
| | their worthiness | my team | feel like | writing and giving a |
| | by leading a | know how | {LEADER} | simple thank you |
| | discussion with | much their | let us know | card in the meeting. |
| | your team on the | effort and | how much | |
| | impact their work | work is | our effort | |
| | has on the | appreciated. | and work is | |
| | organization. | | appreciated. | |
| Towards | In the meeting, | In this | In this | In the next meeting |
| | set a goal to | meeting I let | meeting, I | try to publicly |
| | recognize a | my team | feel like | recognize someone |
| | unique | know how | {LEADER} | during the meeting. |
| | contribution of | much their | let us know | |
| | each team | effort and | how much | |
| | member. | work is | our effort | |
| | | appreciated. | and work is | |
| | | | appreciated. | |
| Awav | In this meeting, | In this | In this | Consider your |
| From | avoid blaming | meeting I let | meeting, I | audience. Which |
| | someone for a | my team | feel like | team members prefer |
| | mistake. Instead, | know how | {LEADER} | public recognition |
| | praise the | much their | let us know | and which ones |
| | individual for the | effort and | how much | would value more |
| | learning and | work is | our effort | private methods. |
| | recovery from | appreciated. | and work is | |
| | that mistake. | | appreciated. | |
| Visual | In this meeting, | In this | In this | Be surprising. Think |
| | show the team | meeting I let | meeting, I | back over the |
| | visually their | my team | feel like | meeting. Where |
| | impact and | know how | {LEADER} | could you have |
| | recognize and | much their | let us know | surprised someone |
| | appreciate that | effort and | how much | with specific |
| | impact. | work is | our effort | praise/recognition? |
| | | appreciated. | and work is | |
| | | | appreciated. | |
| Auditory | In this meeting, | In this | In this | Mini-gifts can be |
| | express your | meeting I let | meeting, I | both effective and |
| | admiration to the | my team | feel like | inexpensive. How |
| | team about the | know how | {LEADER} | might you |
| | contributions of a | much their | let us know | occasionally give |
| | team member and | effort and | how much | mini-gifts as a way to |
| | recognize that | work is | our effort | reward and recognize |
| | person publicly. | appreciated. | and work is | team members? |
| | | | appreciated. | |
| Procedures | In this meeting, | In this | In this | Did you know that |
| | think about the | meeting I let | meeting, I | special assignments |
| | process or steps | my team | feel like | can be very |
| | you could take to | know how | {LEADER} | rewarding to team |
| | start and end the | much their | let us know | members. Be mindful |
| | meeting with | effort and | how much | that strategically |
| | recognition. | work is | our effort | offering someone a |
| | | appreciated. | and work is | special project or |
| | | | appreciated. | assignment can be |
| | | | | rewarding to that |
| | | | | individual. |
| Options | In this meeting, | In this | In this | It's important to be |
| | think about all the | meeting I let | meeting, I | specific when you |
| | opportunities to | my team | feel like | recognize others. |
| | share your | know how | {LEADER} | Take the time to |
| | gratitude and find | much their | let us know | explain why you're |
| | one specific | effort and | how much | recognize someone. |
| | moment to share | work is | our effort | |
| | your gratitude. | appreciated. | and work is | |
| | | | appreciated. | |
| Specific | In this meeting, | In this | In this | Set a goal in each |
| | find a specific | meeting I let | meeting, I | meeting to recognize |
| | moment in the | my team | feel like | the entire team for |
| | meeting to give | know how | {LEADER} | something and to |
| | gratitude for the | much their | let us know | recognize at least one |
| | team's effort. | effort and | how much | individual as well. |
| | | work is | our effort | |
| | | appreciated. | and work is | |
| | | | appreciated. | |
| Global | In this meeting, | In this | In this | What did you learn |
| | take some time to | meeting I let | meeting, I | from the meeting |
| | highlight positive | my team | feel like | when you recognized |
| | feedback and | know how | {LEADER} | a team member? |
| | gratitude that | much their | let us know | Apply that learning |
| | others (your boss, | effort and | how much | to your next meeting. |
| | peers, etc.) have | work is | our effort | |
| | said about the | appreciated. | and work is | |
| | team in the past | | appreciated. | |
| | week. | | | |
| Proactive | In this meeting, | In this | In this | Ask yourself whether |
| | be proactive | meeting I let | meeting, I | recognition programs |
| | about praise and | my team | feel like | such as employee of |
| | recognition by | know how | {LEADER} | the month could work |
| | suggesting a | much their | let us know | for your team. |
| | recognition | effort and | how much | |
| | program the team | work is | our effort | |
| | could do such as | appreciated. | and work is | |
| | employee of the | | appreciated. | |
| | month, peer | | | |
| | recognition | | | |
| | program, or any | | | |
| | others that your | | | |
| | company offers. | | | |
| Reactive | In this meeting, | In this | In this | Before your next |
| | react to any | meeting I let | meeting, I | meeting think about |
| | situation that | my team | feel like | whether any |
| | warrants | know how | {LEADER} | individuals have not |
| | recognition by | much their | let us know | received any |
| | delivering sincere | effort and | how much | recognition or praise |
| | praise. | work is | our effort | in awhile. |
| | | appreciated. | and work is | |
| | | | appreciated. | |
| Standard | In this meeting, | In this | In this | Have you considered |
| | take a moment | meeting I let | meeting, I | recognizing team |
| | and give gratitude | my team | feel like | members for non- |
| | to your team for | know how | {LEADER} | work |
| | their effort on a | much their | let us know | accomplishments? |
| | project/or | effort and | how much | Buying a new house, |
| | opportunity and | work is | our effort | something their |
| | how it positively | appreciated. | and work is | children |
| | impacted you. | | appreciated. | accomplished, etc. |
| Standard | In this meeting, | In this | In this | Are you willing to |
| | take a moment | meeting I let | meeting, I | post and follow a |
| | and give gratitude | my team | feel like | celebration calendar? |
| | to your team for | know how | {LEADER} | |
| | their effort on a | much their | let us know | |
| | project/or | effort and | how much | |
| | opportunity and | work is | our effort | |
| | how it positively | appreciated. | and work is | |
| | impacted the | | appreciated. | |
| | team. | | | |
| Standard | In this meeting, | In this | In this | Where might you |
| | paint a positive | meeting I let | meeting, I | have missed an |
| | picture with your | my team | feel like | opportunity during |
| | team by giving | know how | {LEADER} | the last meeting to |
| | gratitude for their | much their | let us know | give recognition? |
| | efforts. | effort and | how much | Learn from that miss |
| | | work is | our effort | and try again next |
| | | appreciated. | and work is | time. |
| | | | appreciated. | |
| Standard | In this meeting, | In this | In this | What do you think |
| | share the glory | meeting I let | meeting, I | would be an |
| | and use the power | my team | feel like | advantage of |
| | of words and | know how | {LEADER} | encouraging peer-to- |
| | storytelling with | much their | let us know | peer recognition? |
| | your team to give | effort and | how much | |
| | gratitude for their | work is | our effort | |
| | efforts. | appreciated. | and work is | |
| | | | appreciated. | |
| Standard | In this meeting, | In this | In this | William James quote: |
| | think through | meeting I let | meeting, I | The deepest principle |
| | whether there is | my team | feel like | in human nature is to |
| | someone that | know how | {LEADER} | be appreciated. |
| | does not like | much their | let us know | |
| | public praise and | effort and | how much | |
| | avoid making that | work is | our effort | |
| | individual | appreciated. | and work is | |
| | uncomfortable. | | appreciated. | |
| | Do follow up | | | |
| | with that person | | | |
| | and recognize | | | |
| | individually. | | | |
| Standard | In this meeting, | In this | In this | |
| | nurture teamwork | meeting I let | meeting, I | |
| | by encouraging | my team | feel like | |
| | peers to recognize | know how | {LEADER} | |
| | each other. | much their | let us know | |
| | | effort and | how much | |
| | | work is | our effort | |
| | | appreciated. | and work is | |
| | | | appreciated. | |
| Standard | Share with your | In this | In this | |
| | team the gratitude | meeting I let | meeting, I | |
| | you feel for all of | my team | feel like | |
| | their hard work. | know how | {LEADER} | |
| | | much their | let us know | |
| | | effort and | how much | |
| | | work is | our effort | |
| | | appreciated. | and work is | |
| | | | appreciated. | |
| Standard | In this meeting, | In this | In this | |
| | take some time to | meeting I let | meeting, I | |
| | highlight positive | my team | feel like | |
| | feedback and | know how | {LEADER} | |
| | gratitude that | much their | let us know | |
| | others (your boss, | effort and | how much | |
| | peers, etc.) have | work is | our effort | |
| | said about the | appreciated. | and work is | |
| | team in the past | | appreciated. | |
| | week. | | | |

The first (leftmost) column comprises behavioral modalities. There are, in this example, twelve nudges with specific modalities, and eight nudges with standard modalities. The twelve nudges with specific modalities are paired into six groupings.

When a leader onboards (configures their identity in the system), in addition to creating their account, connecting their calendar, selecting areas to grow, and selecting influencers, they answer six profile questions. Each question identifies the primary modality within the paired grouping (to associate them with a primary modality “A” or “B” in each pair).

In this exemplary manner of delivering nudges, if they answered as follows for the six onboarding questions—A,A,B,B,B,A—the system may select and communicate nudges directed to A,A,B,B,B,A. The following six nudges may be configured to be communicated in the opposite sequence, B,B,A,A,A,B. After that, the system may randomize and communicate the remaining eight “standard” nudges, ensuring there is no duplication. When all twenty nudges have been communicated once, the system cycles back to communicating the original six nudges, A,A,B,B,B,A, then the opposite six, then randomized the remaining “standard” nudges.

Meetings to nudge are selected, for example, based on the leader having accepted the meeting (e.g., and not busy or tentative) and the meeting participants including influencers of the leader for particular behavioral modalities. If a meeting is private, out of office, or does not have invitees, it may be excluded.

The system may utilize a contention resolution mechanism. For example, if two or more registered leaders are in the same meeting, the leader who organized the meeting may take priority, unless they have reach a configured time or quantity limit. If the organizing leader has already received their nudge allotment, other leaders may be selected and tested for time and quantity limits. The first one to have an open nudge opportunity and attending the meeting may be identified for nudging for the meeting.

The system may configure constraints on the communication of behavioral nudges. For example, in one embodiment a limit is applied to communication of one behavioral nudge per person in the morning work hours (e.g., between 7 A.M. And 12:00 noon local time) and one nudge in the afternoon work hours (e.g., between 12:00 noon and 6 P.M. local time). Other examples of constraints are configuring the communication of nudges to a particular individual to be greater than three hours apart, and configuring a limit of no more than ten nudges per week per individual.

The system may be configured to communicate behavioral nudges based on triggering events, such as X (e.g., three) minutes prior to the start of a meeting.

Behavioral modalities are associated with different types of meetings. Whether or not a meeting is associated with a particular behavioral modality may be based on a matching, which may be precise or fuzzy, between keywords in the meeting subject and keywords associated with the behavioral modalities. Additionally matching may be based on the number of meeting participants (e.g., whether there are less than or equal to three meeting participants, or more than three). From the behavioral modalities that match a meeting type, one behavioral modality is selected for nudging the meeting leader. The selected behavioral modality may be one that the meeting leader has also selected as a behavioral area they want to develop.

Meeting intent may be in some cases be inferred, in whole or part, by evaluating and weighing keywords in the meeting object, evaluating relationships between attendees, taking into account whether the meeting is a single occurrence or recurring, and consideration of the party that scheduled the meeting. Many other data points about the meeting, the meeting attendees, the history of meetings between the parties, and the meeting object itself may be incorporated into ascertaining the meeting intent. Any of a number of natural language processing (NLP) and machine learning algorithms and structures known in the art may be utilized to ascertain meeting intent.

In one embodiment, a meeting monitor receives triggering events for meeting objects on the calendaring system of configured leaders. Behavioral nudges are generated in response to these triggering events a configured number (e.g., between 2 and 8) of minutes prior to the meeting via a collaboration platform (e.g., via a Microsoft Teams chatbot, G-Suite, Slack, or Zoom). The meeting monitor may generate additional behavioral nudges during the meeting itself, based on interaction between the leader and other meeting participants.

Once a meeting concludes, the meeting monitor may communicate to the meeting leader a behavioral area-specific self-rating prompt via the collaboration platform. Selected ones of the meeting participants may also be prompted by the meeting monitor to rate the leader in certain behavioral areas. The meeting participants selected to provide ratings may be those meeting participants configured to be influencers of the leader, and in one embodiment may be only those meeting participants configured to influencers in the specific behavioral area corresponding to the behavioral nudge provided to the leader prior to the meeting. In one embodiment the influencer ratings are anonymized.

In one embodiment, a feedback threshold is configured in the system such that any feedback is only applied to the learning retention system on condition of satisfying the threshold. For example, in one embodiment three or more influencers must provide quantitative feedback on the leader in the relevant behavioral area in order to enable application of the feedback for learning retention. In one embodiment quantitative feedback that satisfies the threshold is averaged into a metric and utilized to determine a perception gap with the leader's self-rating.

In one embodiment, the scoring of a leader's performance in a configured behavioral area is weighted according to a level of detected engagement by meeting participants (how much did a particular meeting participant speak, for example), and/or by a metric of meeting effectiveness (which may be ascertained by polling the meeting participants). The behavioral nudges selected in response to future triggering events may also be influenced by meeting engagement.

In one embodiment the self-rating and average of the meeting participant influencer scores are presented to the user along with the calculated difference (perception gap). A random “nano-learning” message is also presented to the user based on the behavioral area. A user receiving this information may at that time request written feedback in more detail from the meeting participants that provided ratings. If such feedback is received, the user may respond with a ‘thank you’. Throughout this bidirectional communication, anonymity of the raters is maintained from the person being rated.

The system may calculate or update various metrics based on the ratings, detailed feedback, and/or perception gap. These metrics include a cycle metric, a behavioral area metric, a behavioral dimension metric, a behavioral theme metric, and an overall leadership metric.

In one embodiment the cycle metric is determined as follows:

(((self-rating(25%)+average of influencer ratings(75%))×20)=cycle metric

The cycle metric may not be computed when no influencers for the leader from among the meeting participants provide a rating (i.e., an incomplete cycle).

In one embodiment the behavioral area metric is computed to be an average of the last ten (more generally, N>2) cycle metrics for a particular behavioral area. If there have been less than ten cycles for that behavioral area, this metric may be computed as an average of metrics for available complete cycles for the behavioral area.

In one embodiment the behavioral dimension metric is computed as an average of a last ten (more generally, N>2) cycles metrics for each behavioral area classified in a particular dimension.

For example, being “succinct and direct” and “communicating relentlessly” may be two behavioral areas belonging to the same behavioral dimension. In March of a given year, a user may have fifteen completed cycle metrics for January and February of that year in the behavioral area of being “succinct and direct”, and five completed cycle metrics for the currently-active behavioral area of “communicating relentlessly”. In this example, the system may combine the last ten cycle metrics from “succinct and direct” with the five cycle metrics for “communicating relentlessly” and average these fifteen metrics for a dimension metric.

The theme metric may be computed as an average of the last N>2 (e.g., ten) cycle metrics for each behavioral area classified into a particular behavioral theme. Tables 2, 3, and 4 below provides examples of behavioral themes.

Strengthening Trust & Relationships

TABLE 2

| | | |
|---|---|---|
| Coaching for Success | Giving Praise & Recognition | Providing Constructive Feedback |
| | Developing Others | |
| Building Great Teams | Engaging & Inspiring Others | Driving Accountability |
| | Providing Resources | Delegating Effectively |
| | Maintaining High Standards | |
| Collaborating Effectively | Strengthening Relationships | Building Your Leadership Brand |
| | Influencing & Negotiating | Increasing Your Political Savviness |
| | Managing Conflict | |

Driving Organization Performance

TABLE 3

| | | |
|---|---|---|
| Being Productive | Making Meetings Meaningful | Managing Your Time |
| | Leading Great Virtual Meetings | Planning & Organizing for Success |
| Making Informed Decisions | Analyzing Issues | Building Business Acumen |
| | Enabling Innovation & Creativity | Having a Bias for Action |
| | Growing Managerial Courage | |
| Increasing Agility | Leading Change | Managing Through Ambiguity |
| | Becoming Agile | Maintaining Perseverance & Composure |
| Thinking Strategically | Motivating with Vision & Purpose | Being a Big Picture Thinker |
| | Becoming Customer-Centric | Driving Continuous Improvement |
| | Applying Technology | |

Creating a Culture for all

TABLE 4

| | | |
|---|---|---|
| Being Authentic | Increasing Self Awareness | Creating a Learning Mindset |
| | Building Integrity & Trust | Growing Compassion |
| | Being Relatable | |
| Communicating Effectively | Being Succinct & Direct | Communicating Openly |
| | Communicating Relentlessly | Building Presentation Skills |
| | Storytelling for Impact | |
| Building Diversity, Equity, | Establishing Your Principles | Being Fair & Equitable |
| & Inclusion | Building Inclusion | Driving Diversity |

The leader metric may be calculated as an average of a last N>2 (e.g., ten) cycle metrics for all behavioral areas worked by the leader.

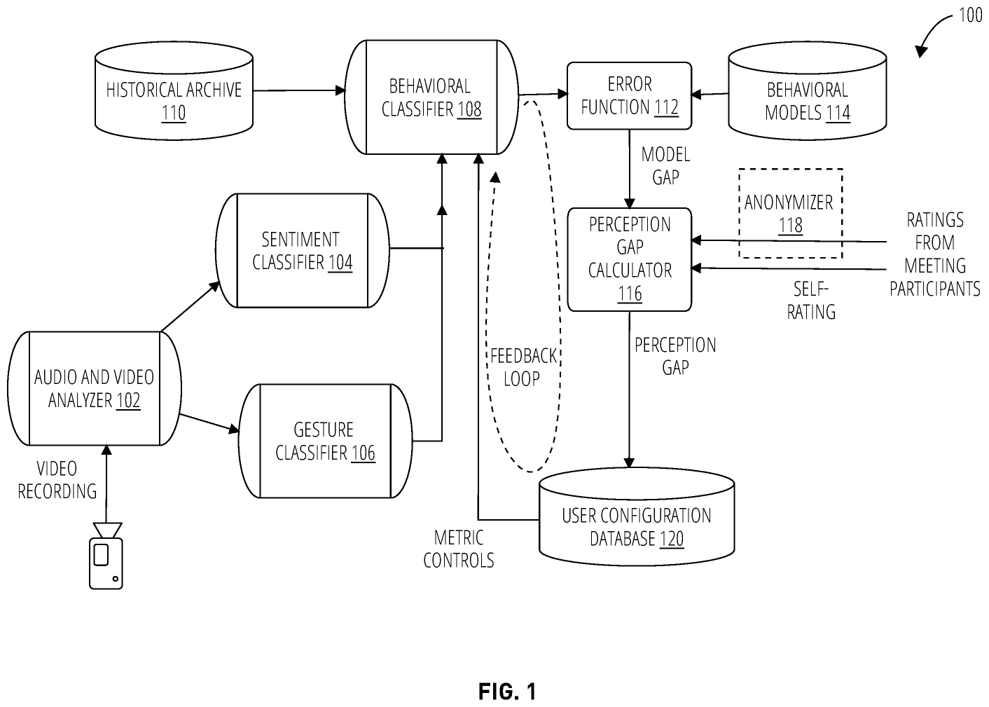

FIG. 1 depicts an analytic system 100 in one embodiment. A video recording of a meeting is generated and input to a video analyzer 102, which comprises (among other algorithms to detect and convert speech to text, etc.) a sentiment classifier 104 and a gesture classifier 106. The sentiment classifier 104 and gesture classifier 106 generate feature vectors (arrays of values) indicative of sentiments and gestures presented by meeting participants (including the meeting leader) in the meeting. The sentiment and gesture metrics may be generated only for the leader, or for the leader and others. The feature vectors are input to a behavioral classifier 108, which in one embodiment comprises one or more neural networks trained to classify behavioral modalities and/or behavioral areas. Such classifiers, and how to train them, are known in the art. The behavioral classifier 108 may also utilize gesture and sentiment data, in the form of input feature vectors, from a historical archive 110 generated from recordings of the leader's (or other's) prior meetings.

In some embodiments, the classifications generated by the behavioral classifier 108 are compared by an error function 112 with ideal metrics for the behavioral areas from a set of one or more behavioral models 114 to generate a model gap. The model gap is input, along with ratings from the meeting participants (including a self-rating from the meeting leader) to a perception gap calculator 116 that generates a perception gap between the meeting leader's perception of his behavior, and that of others and/or the ideal behavioral model(s). The ratings from the other meeting participants may (optionally) be anonymized via an anonymizer 118. Some embodiments may not generate or utilize the model gap to calculate the perception gap.

The perception gap (and also typically the self-rating and ratings from other meeting participants) is stored in a user configuration database 120 and also utilized as metric controls in a feedback loop to adapt the behavioral classifier 108, e.g., as a feedback signal to change weights and/or activations of a neural network embodiment of the behavioral classifier 108. In other words, the metric controls are generated in manners known in the art to be adaptive learning signals to a machine-logic classifier algorithm. The exact manner of generating the metric controls from the perception gap, and/or raw ratings, and/or model gap, are specific in manners known in the art to the implementation of the behavioral classifier 108.

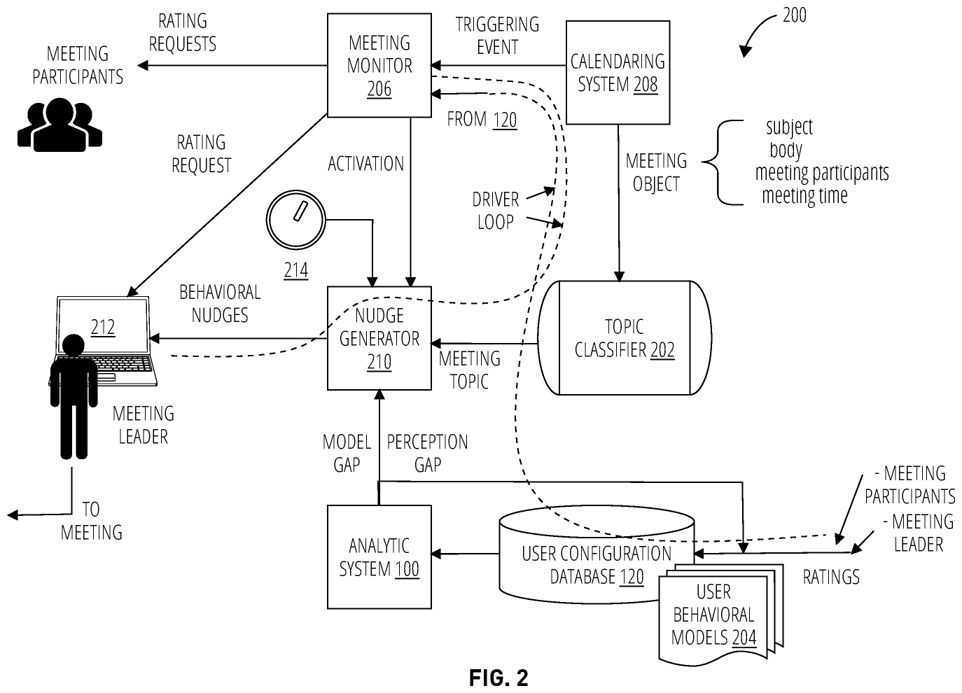

The values stored in the user configuration database 120 are also utilized to control a driver loop for the system, as described further in conjunction with FIG. 2.

FIG. 2 depicts a feedback driver loop 200 in one embodiment. Settings in the user configuration database 120, such as a user's configured behavioral areas to train, ratings they have received for those areas, perception gaps, and (optionally in some embodiments) one or more user behavioral models 204 for the user, are applied to a meeting monitor 206. Examples of meeting monitor logic were described previously. The meeting monitor 206 initiates actions in a driver loop for the analytic system 100 and the learned classifier adaptations therein. The driver loop also drives learning loops for meeting leaders by responding to triggering events from the calendaring system 208 to generate activations to a nudge generator 210, and rating requests to meeting participants (e.g., to their user devices 212 such as phones and computers).

Depending on the implementation, the meeting monitor 206 may “pull” triggering events from the calendaring system 208, or may receive “pushes” of triggering events from the calendaring system 208.

The nudge generator 210 operates on the activations from the meeting monitor 206, and inputs from a clock 214 and topic classifier 202, to determine timing and content of the behavioral nudges. For example as previously described in one example, the nudge generator 210 may select content for the behavioral nudge based on content of a meeting object (such as the meeting topic) provided by the calendaring system 208. Application program interfaces for obtaining the meeting object and/or triggering event from the calendaring system 208 are known in the art and will depend upon the calendaring system utilized. In one embodiment the topic classifier 202 analyzes one or more of the meeting subject text, meeting participants, and text in the body of the meeting object to determine the meeting topic. For example particular meeting participants configured as influencers for a particular behavioral area may be indicative of a particular meeting topic; certain keywords detected in the meeting subject and/or body may be configured as being indicative of certain meeting topics; and so on.

FIG. 3 depicts a driver loop control 300 in one embodiment. A sequencer 304 selects messages from a message relational map 302 to communicate to a user device 212 in a particular order. The sequencer 304 is responsive to a counter, which enables or disables the sequencer 304 based on a count of messages sent. When the counter 306 disables the sequencer 304 upon reaching a configured message count to the user device 212, it activates a randomizer 308 that selects messages of a different type (as configured in the message relational map 302) for communication to the user device 212. The randomizer 308 is also responsive to a counter 310 (which may be the same counter 306 that controls the sequencer 304 in some embodiments). To prevent duplication, the output of the randomizer 308 is filtered/gated by a duplicate detector 312.

A mode select 314 determines the category of messages to send, based on timing (e.g., relative to the start or end of a meeting), or other factors previously described. Exemplary modes of communication that may be selected are communication of behavioral nudges, survey questions for leaders, survey questions to followers, and learning messages.

Table 1 above depicts an example implementation of the message relational map 302. The first (leftmost) column comprises behavioral modalities. There are, in this example, twelve nudges with specific modalities, and eight nudges with standard modalities. The twelve nudges with specific modalities are paired into six groupings.

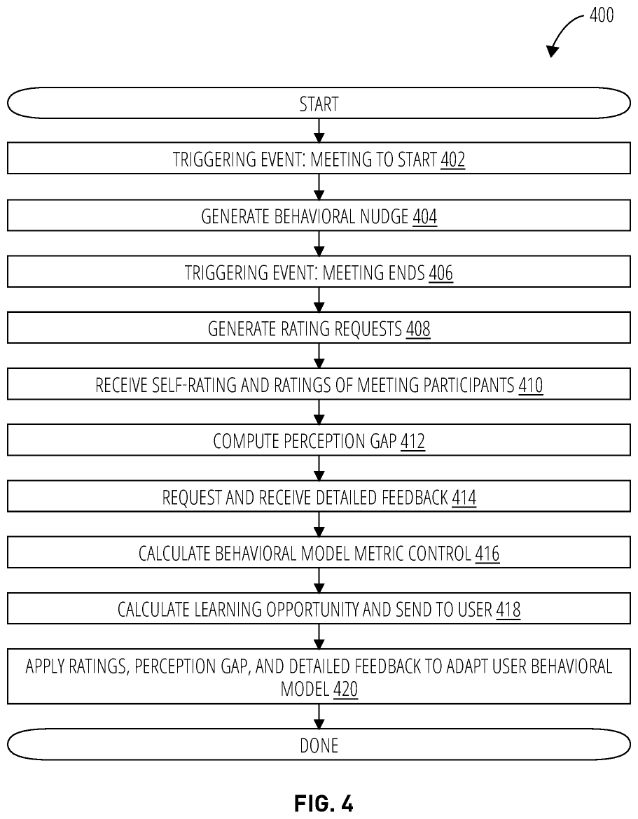

FIG. 4 depicts a process 400 in one embodiment. A triggering event is detected, e.g. a meeting embodied as a meeting object on a calendaring system that will start within some configured interval (block 402). In response to the triggering event, a behavioral nudge is selected and generated, e.g., from the message relational map 302 (block 404). Another triggering event is detected (block 406), this time for example indicative of the meeting coming to an end (as indicated by the interval of the meeting object). In response to this second triggering event, rating requests are selected and generated, e.g., from the message relational map 302 (block 408).

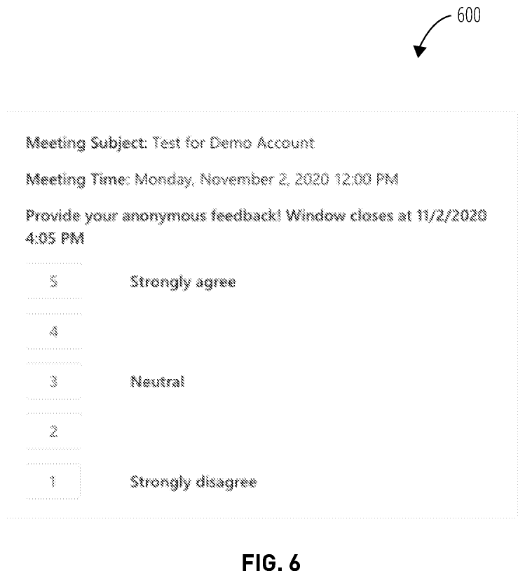

The meeting leader receives a self-rating request, and the other meeting participants (that are configured as influencers for the meeting leader) receive rating requests (block 410). An exemplary rating request is depicted in FIG. 6, where the generated rating metric is quantized to a value over a small range, e.g., 1-5. The self-rating request may be similar in some embodiments.

Based on responses to these requests, the system computes a perception gap (block 412). In some cases, the system may then proceed to request more detailed feedback (than provided in the responses to the rating requests) from the other meeting participants and/or the meeting leader (block 414). The previously described metric control may be generated from any or some of the responses (to the rating requests and/or requests for details (block 416).

A learning opportunity message may be selected (e.g., from the message relational map 302), based for example on the opportunity messages associated with the behavioral area implicated for the meeting leader in the meeting object. This message is communicated to the meeting leader (block 418). The metric control determined at block 416 may be applied to adapt the behavioral model for the meeting leader (block 420).

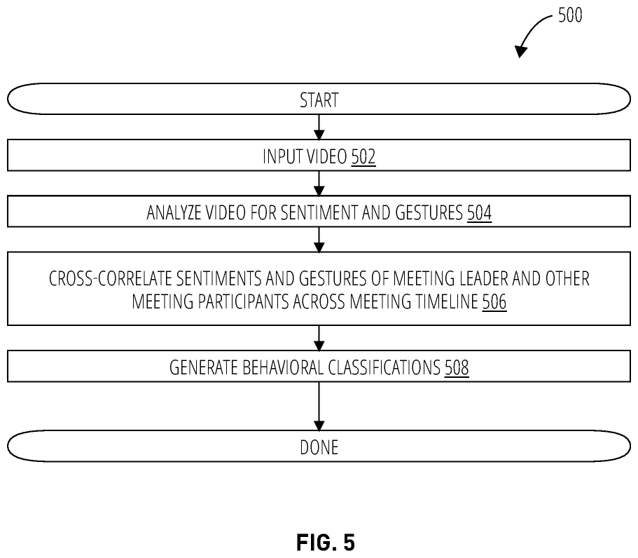

FIG. 5 depicts a process 500 in one embodiment. A video feed (either recorded or live) is input to an analytic system 100 (block 502) that analyzes the video for sentiment and gestures (block 504). The analysis may be carried out only for a meeting leader depicted in the video (identified for example via facial recognition, voice recognition, or position in the field of view of the camera), or alternatively, may be carried out for each person that acts as a speaker in the meeting. In manners known in the art, sentiment analysis algorithms may utilize voice-to-text conversion algorithms, voice analysis such as inflection, pauses, hesitancy, volume etc., natural language processing for word/phrase usage and meaning, and in some cases the gesture analysis, to determine a cross-correlation of sentiment metrics and/or gestures is made for the speakers that are analyzed across the meeting timeline (506). Behavioral classifications are then generated from the sentiment and/or gesture feature vectors, as correlated, for one or more of the speakers (block 508).

The systems disclosed herein, or particular components thereof, may in some embodiments be implemented as software comprising instructions executed on one or more programmable device. By way of example, components of the disclosed systems may be implemented as an application, an app, drivers, or services. In one particular embodiment, the system is implemented as a service that executes as one or more processes, modules, subroutines, or tasks on a server device so as to provide the described capabilities to one or more client devices over a network. However the system need not necessarily be accessed over a network and could, in some embodiments, be implemented by one or more app or applications on a single device or distributed between a mobile device and a computer, for example.

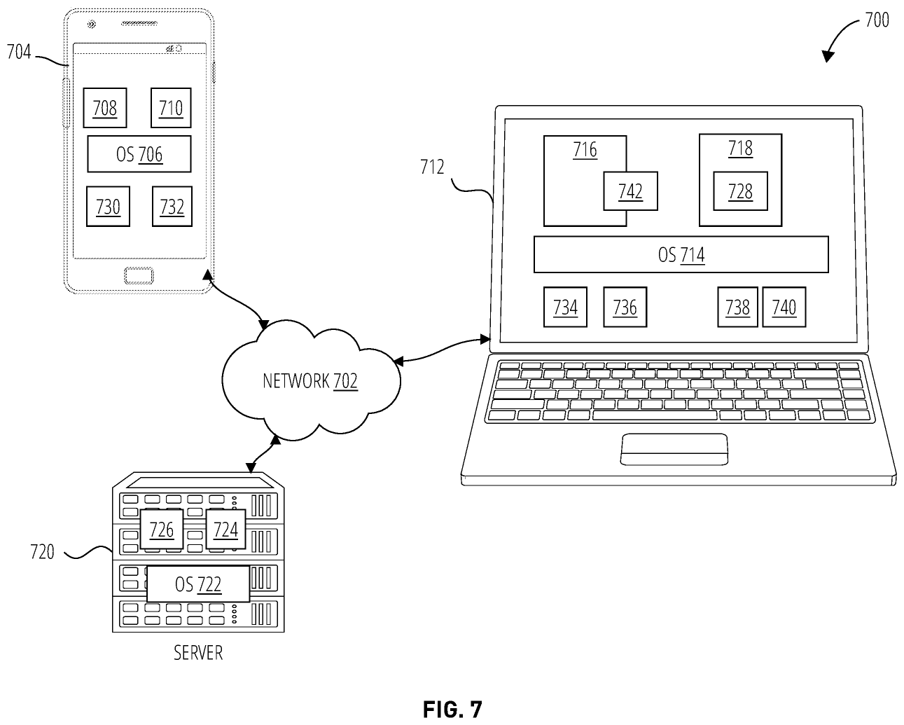

Referring to FIG. 7, a client server network configuration 700 illustrates various computer hardware devices and software modules coupled by a network 702 in one embodiment. Each device includes a native operating system, typically pre-installed on its non-volatile RAM, and a variety of software applications or apps for performing various functions.

The mobile programmable device 704 comprises a native operating system 706 and various apps (e.g., app 708 and app 710). A computer 712 also includes an operating system 714 that may include one or more library of native routines to run executable software on that device. The computer 712 also includes various executable applications (e.g., application 716 and application 718). The mobile programmable device 704 and computer 712 are configured as clients on the network 702. A server 720 is also provided and includes an operating system 722 with native routines specific to providing a service (e.g., service 724 and service 726) available to the networked clients in this configuration.

As is well known in the art, an application, an app, or a service may be created by first writing computer code to form a computer program, which typically comprises one or more computer code sections or modules. Computer code may comprise instructions in many forms, including source code, assembly code, object code, executable code, and machine language. Computer programs often implement mathematical functions or algorithms and may implement or utilize one or more application program interfaces.

A compiler is typically used to transform source code into object code and thereafter a linker combines object code files into an executable application, recognized by those skilled in the art as an “executable”. The distinct file comprising the executable would then be available for use by the computer 712, mobile programmable device 704, and/or server 720. Any of these devices may employ a loader to place the executable and any associated library in memory for execution. The operating system executes the program by passing control to the loaded program code, creating a task or process. An alternate means of executing an application or app involves the use of an interpreter (e.g., interpreter 728).

In addition to executing applications (“apps”) and services, the operating system is also typically employed to execute drivers to perform common tasks such as connecting to third-party hardware devices (e.g., printers, displays, input devices), storing data, interpreting commands, and extending the capabilities of applications. For example, a driver 730 or driver 732 on the mobile programmable device 704 or computer 712 (e.g., driver 734 and driver 736) might enable wireless headphones to be used for audio output(s) and a camera to be used for video inputs. Any of the devices may read and write data from and to files (e.g., file 738 or file 740) and applications or apps may utilize one or more plug-in (e.g., plug-in 742) to extend their capabilities (e.g., to encode or decode video files).

The network 702 in the client server network configuration 700 can be of a type understood by those skilled in the art, including a Local Area Network (LAN), Wide Area Network (WAN), Transmission Communication Protocol/Internet Protocol (TCP/IP) network, and so forth. These protocols used by the network 702 dictate the mechanisms by which data is exchanged between devices.

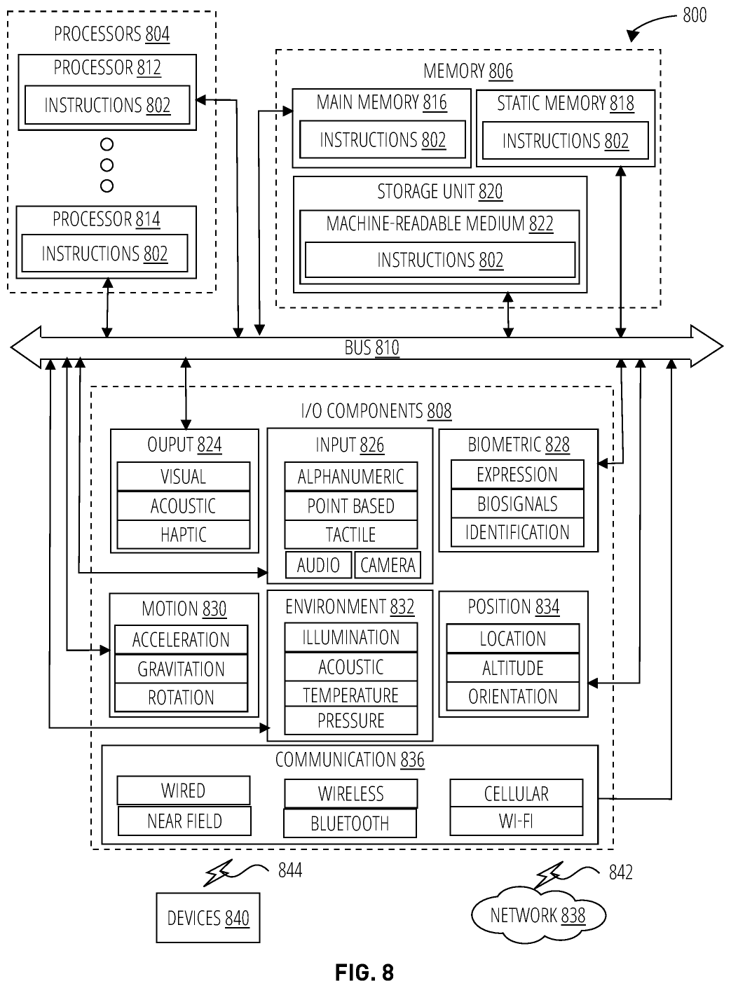

FIG. 8 depicts a diagrammatic representation of a machine 800 in the form of a computer system within which logic may be implemented to cause the machine to perform any one or more of the functions or methods disclosed herein, according to an example embodiment.

Specifically, FIG. 8 depicts a machine 800 comprising instructions 802 (e.g., a program, an application, an applet, an app, or other executable code) for causing the machine 800 to perform any one or more of the functions or methods discussed herein. The instructions 802 configure a general, non-programmed machine into a particular machine 800 programmed to carry out said functions and/or methods.

In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 802, sequentially or otherwise, that specify actions to be taken by the machine 800. Further, while only a single machine 800 is depicted, the term “machine” shall also be taken to include a collection of machines that individually or jointly execute the instructions 802 to perform any one or more of the methodologies or subsets thereof discussed herein.

The machine 800 may include processors 804, memory 806, and I/O components 808, which may be configured to communicate with each other such as via one or more bus 810. In an example embodiment, the processors 804 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, one or more processor (e.g., processor 812 and processor 814) to execute the instructions 802. The term “processor” is intended to include multi-core processors that may comprise two or more independent processors (sometimes referred to as “cores”) that may execute instructions contemporaneously. Although FIG. 8 depicts multiple processors 804, the machine 800 may include a single processor with a single core, a single processor with multiple cores (e.g., a multi-core processor), multiple processors with a single core, multiple processors with multiples cores, or any combination thereof.

The memory 806 may include one or more of a main memory 816, a static memory 818, and a storage unit 820, each accessible to the processors 804 such as via the bus 810. The main memory 816, the static memory 818, and storage unit 820 may be utilized, individually or in combination, to store the instructions 802 embodying any one or more of the functionality described herein. The instructions 802 may reside, completely or partially, within the main memory 816, within the static memory 818, within a machine-readable medium 822 within the storage unit 820, within at least one of the processors 804 (e.g., within the processor's cache memory), or any suitable combination thereof, during execution thereof by the machine 800.

The I/O components 808 may include a wide variety of components to receive input, provide output, produce output, transmit information, exchange information, capture measurements, and so on. The specific I/O components 808 that are included in a particular machine will depend on the type of machine. For example, portable machines such as mobile phones will likely include a touch input device or other such input mechanisms, while a headless server machine will likely not include such a touch input device. It will be appreciated that the I/O components 808 may include many other components that are not shown in FIG. 8. The I/O components 808 are grouped according to functionality merely for simplifying the following discussion and the grouping is in no way limiting. In various example embodiments, the I/O components 808 may include output components 824 and input components 826. The output components 824 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 826 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), one or more cameras for capturing still images and video, and the like.

In further example embodiments, the I/O components 808 may include biometric components 828, motion components 830, environmental components 832, or position components 834, among a wide array of possibilities. For example, the biometric components 828 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 830 may include acceleration sensor components (e.g., accelerometer), gravitation sensor components, rotation sensor components (e.g., gyroscope), and so forth. The environmental components 832 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 834 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 808 may include communication components 836 operable to couple the machine 800 to a network 838 or devices 840 via a coupling 842 and a coupling 844, respectively. For example, the communication components 836 may include a network interface component or another suitable device to interface with the network 838. In further examples, the communication components 836 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 840 may be another machine or any of a wide variety of peripheral devices (e.g., a peripheral device coupled via a USB).

Moreover, the communication components 836 may detect identifiers or include components operable to detect identifiers. For example, the communication components 836 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 836, such as location via Internet Protocol (IP) geolocation, location via Wi-Fi® signal triangulation, location via detecting an NFC beacon signal that may indicate a particular location, and so forth.

The various memories (i.e., memory 806, main memory 816, static memory 818, and/or memory of the processors 804) and/or storage unit 820 may store one or more sets of instructions and data structures (e.g., software) embodying or utilized by any one or more of the methodologies or functions described herein. These instructions (e.g., the instructions 802), when executed by processors 804, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors and internal or external to computer systems. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such intangible media, at least some of which are covered under the term “signal medium” discussed below.

Some aspects of the described subject matter may in some embodiments be implemented as computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular data structures in memory. The subject matter of this application may be practiced in a variety of system configurations, including hand-held devices, consumer electronics, general-purpose computers, more specialty computing devices, etc. The subject matter may also be practiced in distributed computing environments where tasks are performed by remote-processing devices that are linked through a communications network.

In various example embodiments, one or more portions of the network 838 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 838 or a portion of the network 838 may include a wireless or cellular network, and the coupling 842 may be a Code Division Multiple Access (CDMA) connection, a Global System for Mobile communications (GSM) connection, or another type of cellular or wireless coupling. In this example, the coupling 842 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 802 and/or data generated by or received and processed by the instructions 802 may be transmitted or received over the network 838 using a transmission medium via a network interface device (e.g., a network interface component included in the communication components 836) and utilizing any one of a number of well-known transfer protocols (e.g., hypertext transfer protocol (HTTP)). Similarly, the instructions 802 may be transmitted or received using a transmission medium via the coupling 844 (e.g., a peer-to-peer coupling) to the devices 840. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 802 for execution by the machine 800, and/or data generated by execution of the instructions 802, and/or data to be operated on during execution of the instructions 802, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### LISTING OF DRAWING ELEMENTS

100 analytic system
102 video analyzer
104 sentiment classifier
106 gesture classifier
108 behavioral classifier
110 historical archive
112 error function
114 behavioral models
116 perception gap calculator
118 anonymizer
120 user configuration database
200 feedback driver loop
202 topic classifier
204 user behavioral models
206 meeting monitor
208 calendaring system
210 nudge generator
212 user device
214 clock
300 driver loop control
302 message relational map
304 sequencer
306 counter
308 randomizer
310 counter
312 duplicate detector
314 mode select
400 process
402 block
404 block
406 block
408 block
410 block
412 block
414 block
416 block
418 block
420 block
500 process
502 block
504 block
506 block
508 block
600 survey
700 client server network configuration
702 network
704 mobile programmable device
706 operating system
708 app
710 app
712 computer
714 operating system
716 application
718 application
720 server
722 operating system
724 service
726 service
728 interpreter
730 driver
732 driver
734 driver
736 driver
738 file
740 file
742 plug-in
800 machine
802 instructions
804 processors
806 memory
808 I/O components
810 bus
812 processor
814 processor
816 main memory
818 static memory
820 storage unit
822 machine-readable medium
824 output components
826 input components
828 biometric components
830 motion components
832 environmental components
834 position components
836 communication components
838 network
840 devices
842 coupling
844 coupling

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A closed loop system comprising:
a meeting monitor configured to monitor a calendaring system and generate a behavioral nudge to a first meeting participant at a time determined by a meeting object of the calendaring system;
the meeting monitor configured to detect an end of a meeting corresponding to the meeting object and in response to communicate (a) a self-assessment message to the first meeting participant, and (b) a plurality of assessments of the first meeting participant each to a different meeting participant configured as an influencer of the first meeting participant; and
logic to transform responses to the self-assessment and plurality of assessments into a perception gap for a behavioral area corresponding to the behavioral nudge and apply the perception gap to selection of a next behavioral nudge for the behavioral area prior to a start time defined by a future meeting object of the calendaring system.

2. The closed loop system of claim 1, further comprising:
a video analysis system;
a behavioral classifier coupled to transform output of the video analysis system into behavioral area classifications; and
logic to utilize the behavioral area classifications to generate the perception gap.

3. The closed loop system of claim 2, wherein the perception gap is utilized in feedback to adapt the behavioral classifier.

4. The closed loop system of claim 2, wherein the perception gap is utilized in feedback to the first meeting participant.

5. The closed loop system of claim 1, further comprising a feedback loop driver.

6. The closed loop system of claim 5, the feedback loop driver comprising:
a behavioral nudge sequencer; and
a behavioral nudge randomizer.

7. The closed loop system of claim 6, the behavioral nudge sequencer controlled by a counter.

8. The closed loop system of claim 6, the behavioral nudge randomizer controlled by a counter.

9. The closed loop system of claim 6, the behavioral nudge sequencer and the behavioral nudge randomizer configured to operate sequentially from one another to select and generate behavioral nudges for the first meeting participant.

10. The closed loop system of claim 5, further comprising:
logic to select the behavioral nudge based on a meeting subject extracted from the meeting object.

11. A computer system comprising:
at least one processor;
at least one memory comprising instructions that, when applied to the at least one processor, configure the computer system to:
monitor a calendaring system and generate a behavioral nudge to a first meeting participant at a time determined by a meeting object of the calendaring system;
detect an end of a meeting corresponding to the meeting object and in response to communicate (a) a self-assessment message to the first meeting participant, and (b) a plurality of assessments of the first meeting participant each to a different meeting participant configured as an influencer of the first meeting participant;
transform responses to the self-assessment and plurality of assessments into a perception gap for a behavioral area corresponding to the behavioral nudge; and
apply the perception gap to selection of a next behavioral nudge for the behavioral area prior to a start time defined by a future meeting object of the calendaring system.

12. The computer system of claim 11, the at least one memory comprising instructions that, when applied to the at least one processor, further configure the computer system to:
transform output of a video analysis system into behavioral area classifications; and
utilize the behavioral area classifications to generate the perception gap.

13. The computer system of claim 12, the at least one memory comprising instructions that, when applied to the at least one processor, further configure the computer system to:
utilize the perception gap in feedback to adapt the behavioral classifier.

14. The computer system of claim 12, the at least one memory comprising instructions that, when applied to the at least one processor, further configure the computer system to:
perform sentiment analysis and gesture analysis.

15. The computer system of claim 11, the at least one memory comprising instructions that, when applied to the at least one processor, further configure the computer system to:
implement a feedback loop driver.

16. The computer system of claim 15, the feedback loop driver comprising:
a behavioral nudge sequencer; and
a behavioral nudge randomizer.

17. The computer system of claim 16, the behavioral nudge sequencer controlled by a counter.

18. The computer system of claim 16, the behavioral nudge randomizer controlled by a counter.

19. The computer system of claim 16, the behavioral nudge sequencer and the behavioral nudge randomizer configured to operate sequentially from one another to select and generate behavioral nudges for the first meeting participant.

20. The computer system of claim 15, the at least one memory comprising instructions that, when applied to the at least one processor, further configure the computer system to:
select the behavioral nudge based on a meeting subject extracted from the meeting object.
